(19) United States
(12) Patent Application Publication
(10) Pub. No.: US 2017/0200351 A1
(43) Pub. Date: Jul. 13, 2017

(54) Sound-Producing Shoe Including Impact and Proximity Detections

(71) Applicant: Robert Grubba, Ormond Beach, FL (US)

(72) Inventor: Robert Grubba, Ormond Beach, FL (US)

(21) Appl. No.: 14/992,118

(22) Filed: Jan. 11, 2016

(51) Int. Cl. G08B 3/10; A43B 3/00

(52) U.S. Cl. CPC G08B 3/10; A43B 3/0021

(57) ABSTRACT

A shoe incorporating sound-reproducing equipment that is triggered by the detection of one or more conditions. One of the conditions is the impact of the shoe with the ground, such as when a user stomps the heel on the ground. Another condition is the proximity of a second shoe to a first shoe, such as when a user moves the left shoe of a pair close to the right shoe. The detection of an impact may he used to trigger the reproduction of any desired sound—such as the “chuff” sound of a steam locomotive. The detection of the proximity of another shoe may be used to trigger the reproduction of a different sound—such as a steam whistle.

### BACKGROUND OF THE INVENTION

1. Field of the Invention

This invention relates to the field of footwear. More specifically, the invention comprises a shoe that reproduces a pre-recorded sound upon the detection of one or more sensor inputs.

2. Description of the Related Art

FIG. 1 depicts a prior art shoe that uses an impact between the shoe's sole and the ground to trigger a flashing light. This feature can provide enhanced safety for persons running in low light conditions. It can also provide entertainment, primarily for young users who enjoy the flashing of the light with each step. In the version shown, impact sensor 16 is located in the area beneath the ball of the foot. Controller 12 includes the electronics needed to receive the impact signal from impact sensor 16 and activate the desired output (generally a single flash from LED 18). Power source 14 provides electrical energy to the components shown. In this version the power source is simply a pair of hearing aid batteries connected in series. An access port is provided in the bottom of the shoe so that the batteries may be replaced.

There are several different types of light-producing shoes known in the market. In other versions the impact sensor is located proximate the user's heel. The sensor then tends to be actuated by a stomping motion rather than a normal running motion.

Sound-producing shoes are also known. These employ a triggering sensor as for the shoe of FIG. 1 but they produce a sound effect instead of the pulsing light output. The sound effect may be a simple chirp or may be a more complex sequence of pre-recorded sounds.

It is preferable for these sound and light-producing shoes to retain the desirable characteristics of a conventional shoe, such as shock-cushioning and pliability. It may therefore benefit the reader's understanding to explore some of the features of a conventional shoe before turning to the descriptions of the present invention. FIGS. 2 and 3 depict some of the internal features of present-day running shoes.

FIG. 2 is a sectional elevation view through the heel 20 region of the shoe. Sole 22 is made of an abrasion-resistant material that gives good surface adhesion as well. Midsole 24 is made of a much softer material intended primarily for shock absorption. Open or close-cell foams are often used for the midsole. Bolster 26 surrounds and reinforces the rear of the shoe. It is often made of a material that is less stiff than sole 22 but more stiff than midsole 24. The bolster is often configured to limit the rolling motion of a user's heel.

Upper 28 is the portion of the shoe that surrounds and captures the user's foot. It is often made as an assembly of multiple pieces and may also include multiple layers. Insole 30 is a removable and washable portion lying directly beneath the user's foot.

FIG. 3 is a sectional elevation view through the toe 32 portion of the same shoe. Midsole 24 tends to be much thinner in this region. In some constructions a different material is used for the midsole that lies beneath the ball of the foot versus the midsole lying beneath the heel. In still other constructions, additional shock absorbing “spring columns” are placed in the midsole beneath the heel. These existing structures are preferably considered and accommodated in the creation of the present invention.

### BRIEF SUMMARY OF THE PRESENT INVENTION

The present invention comprises a shoe incorporating so and-reproducing equipment that is triggered by the detection of one or more condition. One of the conditions is the impact of the shoe with the ground, such as when a user stomps the heel on the ground. Another condition is the proximity of a second shoe to a first shoe, such as when a user moves the left shoe of a pair close to the right shoe. The detection of an impact may be used to trigger the reproduction of any desired sound—such as the “chuff” sound of a steam locomotive. The detection of the proximity of another shoe may be used to trigger the reproduction of a different sound—such as a steam whistle.

The proximity detection may be clone using a variety of different methods. In a preferred embodiment, a magnet is placed in one shoe and the other shoe contains some type of magnetic switch. In another preferred embodiment, infrared light is transmitted by one shoe and reflected to a detector. Other embodiments are disclosed as well.

### BRIEF DESCRIPTION OF THE SEVERAL VIEWS OF THE DRAWINGS

FIG. 1 is a side elevation view, showing some internal components of a prior art shoe that produces a light pulse with every step the user takes.

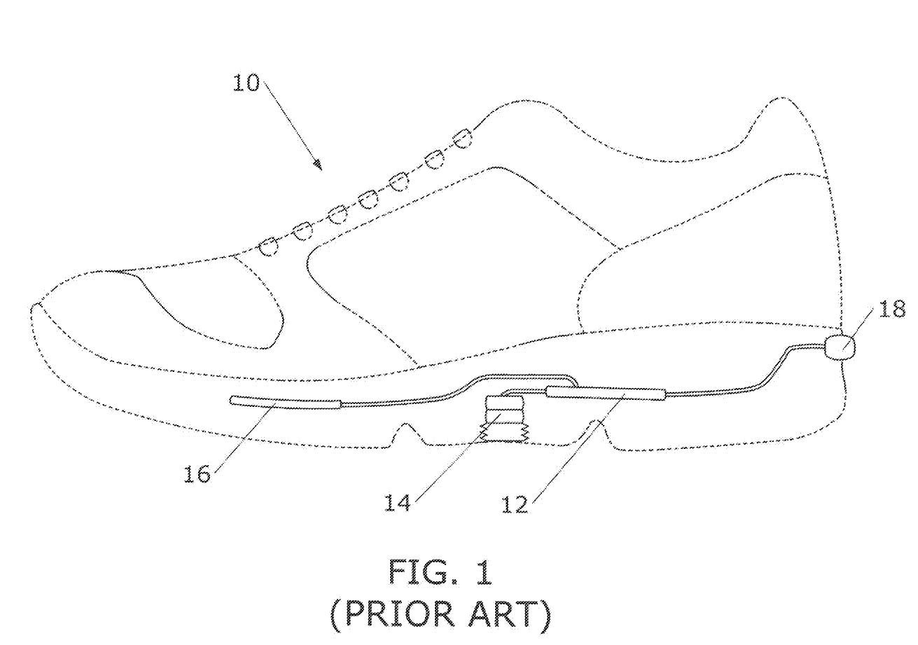

FIG. 2 is a sectional elevation view through the heel portion of a prior art shoe.

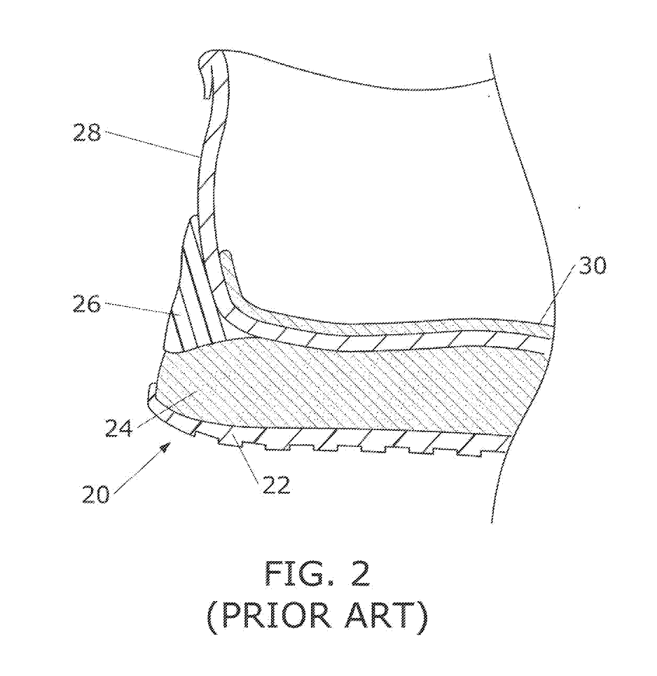

FIG. 3 is a sectional elevation view through the toe portion of a prior art shoe.

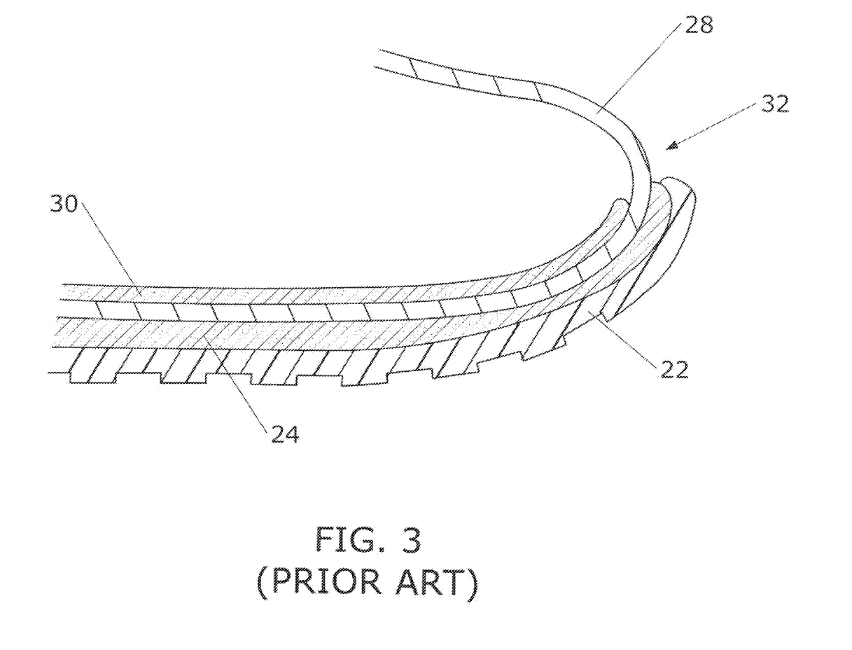

FIG. 4 is a side elevation view showing an embodiment of the present invention.

FIG. 5 is a plan view showing the embodiment of FIG. 4 with the addition of a magnetic proximity sensor.

FIG. 6 is a perspective view, showing an embodiment incorporating a proximity detector based on infrared light.

FIG. 7 is a perspective view, showing an embodiment incorporating a proximity detector based on-a paddle switch.

FIG. 8 is a plan view, showing an embodiment incorporating a proximity detector based on RFID technology.

FIG. 9 is a perspective view, showing an embodiment incorporating a removable battery and an external charging port.

FIG. 10 is a detailed elevation view, showing an embodiment incorporating an inductive charging antenna.

FIG. 11 is a schematic view, showing one possible arrangement for the electronic components of the present invention.

### REFERENCE NUMERALS IN THE DRAWINGS

10 shoe
12 controller
14 power source
16 impact sensor
18 LED
20 heel
22 sole
24 midsole
26 bolster
28 upper
30 insole
32 toe
34 speaker
36 right shoe
38 left shoe
40 magnetic sensor
42 magnet
44 IR emitter
46 IR detector
48 reflector/filter
50 paddle switch
52 RFID transceiver
54 RFID response module
56 battery
58 receiver
60 hatch
62 charge controller
64 inductive charge antenna
66 charging port
68 power bus
70 input
72 processor
74 memory
76 sensor 1
78 sensor 2
80 I/O port
82 B/A converter
84 amplifier
86 output driver
88 rotary input
90 index mark

### DETAILED DESCRIPTION OF THE INVENTION

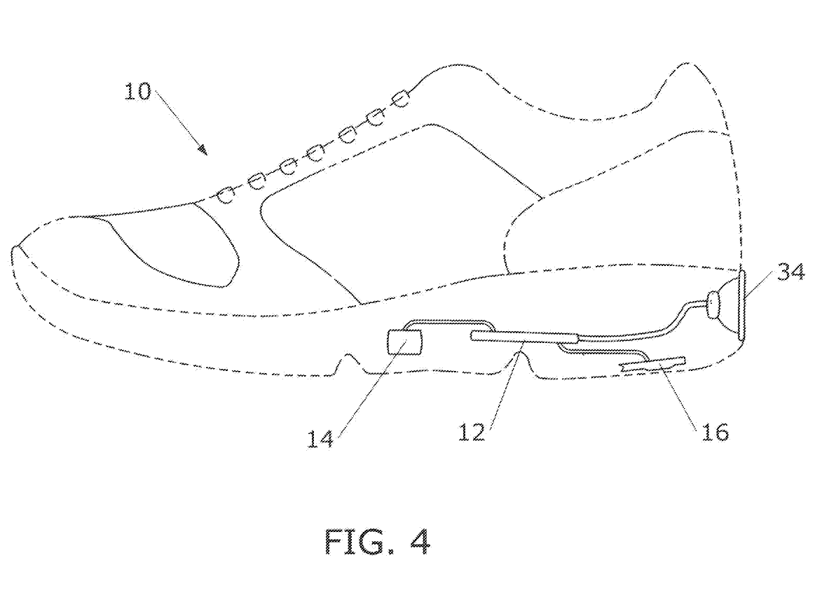

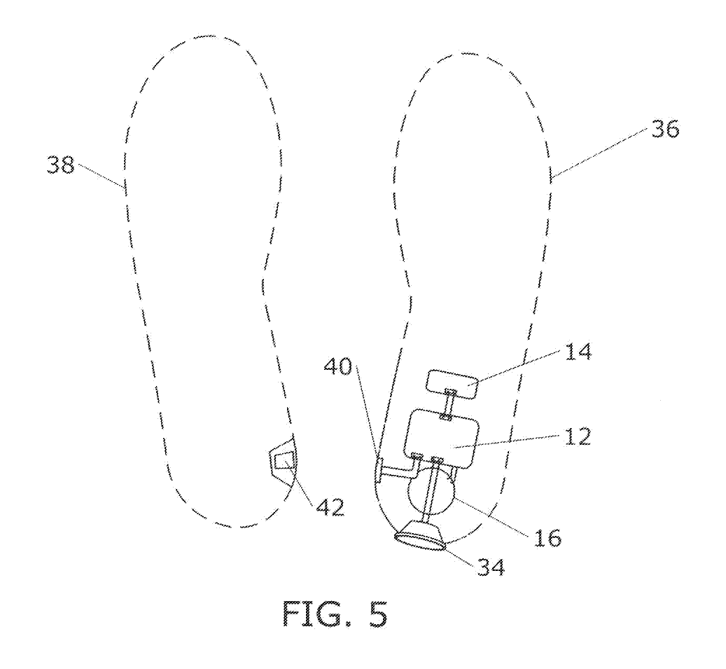

FIGS. 4 and 5 illustrate a first exemplary embodiment of the present invention. FIG. 4 depicts a side elevation view of shoe 10 incorporating the inventive components. Controller 12 and power source 14 are located within the shoe's midsole. Impact sensor 16 is located in this example at the junction between the midsole and the sole. The impact sensor may be configured to detect any desired level of impact. For example, it could be configured to detect every normal step or configured to detect only a hard “stomp” of the user's heel.

Many different types of sensing material may be used for impact sensor 16. As a first example, a simple normally-open contact switch may be used. As a second example, a planar piezoelectric element could be used. The piezoelectric element has the advantage of no moving parts. As those skilled in the art will know, the gain of a piezoelectric element may be selectively adjusted to give varying sensitivity.

Controller 12 incorporates multiple components. In the preferred embodiment, a processor running software is included in the controller. An associated memory is also present. The controller and its associate memory are able to store a recorded sound sequence (preferably in a digital format). The controller also monitors for a triggering event (such as the detection of an impact). When the triggering event occurs, the controller retrieves a desired digital sound file, sends it through a digital to analog converter, amplifies the resulting analog signal, and feeds the analog signal to speaker 34.

Speaker 34 converts the electrical signal to sound energy so that it may be heard by the shoe's wearer and other persons nearby. In the embodiment shown, the speaker is located in the rear portion of shoe 10. It may of course be located in other portions. The speaker preferably includes weather-resistant features as it will likely be exposed to moisture and variable temperatures.

Power source 14 provides electrical power to all the components within the shoe. The power source may be a simple stack of hearing aid batteries connected in series. It may also be a more complex assembly, such as a lithium ion pack connected to a charge controller. The power source may be replenished by any suitable method. In the case of a stack of hearing aid batteries, an access port may be provided to facilitate the removal and replacement of the batteries. In the case of a more complex assembly, an inductive charge antenna may be connected to the charge controller. A simple electrical plug may also be provided so that the shoe can be connected to an external charger when not in use.

All the components within the shoe are preferably made as thin and flat as possible. This allows the components to reside within the pliable components of the shoe without causing discomfort to the user. They may in fact be potted within a semi-pliable polymer to provide structural reinforcement. The placement of the components in the aft portion of the shoe minimizes bending stress. Even so, it is preferable to use components that can repeatedly undergo some bending without failure. As an example, the electrical connection may be made using flat flex circuits rather than simple wiring.

One of the important features of the present invention is its ability to sense an interaction between two shoes (as opposed to just, the actions of a single shoe). FIG. 5 shows a plan view of a preferred embodiment including this ability. Right shoe 36 includes the components illustrated in FIG. 4 (controller 12, power source 14, impact sensor 16, speaker 34). It also includes magnetic sensor 40. Magnetic sensor 40 is configured to detect magnetic phenomena, such as the proximity of a magnetic field or a rate of change of a magnetic field.

Left shoe 38 includes magnet 42. In this version, magnet 42 is positioned so that it will lay proximate magnetic sensor 40 when the heel of left shoe 38 is brought near the heel of right shoe 36. Magnetic sensor 40 will then detect the presence of magnet 42.

The controller and sensors may be configured to create a virtually endless variety of sound effects. One simple example will benefit the reader's understanding. Young children sometimes enjoy the sounds of a steam locomotive. The controller may be used to store the “chuff” sound made by the driving cylinder of a steam locomotive when moving at low speed. Impact sensor 16 may be configured to trigger the “chuff” sound every time the child stomps the heel of the right shoe down.

The controller may also be used to store the sound of a steam train whistle. Magnetic, sensor 40 may be configured to trigger the steam whistle sound every time the heel of left shoe 38 is brought near the heel of right shoe 36. The child then walks forward while bringing the heel of the right shoe down abruptly to create a rhythmic chuffing or “chugging” sound. When the child swings the left heel closely by the right heel a steam train whistle is also produced.

Many other sound effects can be added as well. For example, the controller may log a series of impact sensor actuations hi order to gauge the user's walking speed. The nature of the steam train sounds may then be changed according to speed. Other sounds may be added as well—such as the clanging of a train bell or the hissing of steam letting off when the user stops moving.

Left shoe 38 in the embodiment of FIG. 5 is show as containing only a magnet, but this will not always be the case. In some embodiments, left shoe 38 will contain a separate controller, power supply, impact sensor, speaker, etc. It may then be used to create its own synchronized “chuff” sound every time the left heel is brought down. In this version the user will create a chuff with the right heel and the left heel. The steam train whistle may still be triggered by the magnetic sensor.

Magnetic sensor 40 may assume many forms. A simple version might use a magnetic reed switch that is normally open and that will close when magnet 42 comes near. A more complex version might use a Hall effect sensor. As those skilled in the art will know, a Hall effect sensor varies its output voltage in response to a magnetic field. A Hall effect sensor may be configured to act as a switch (having only an on/off mode). It may also be configured to detect the rate of change of a magnetic field. In this latter case, the triggering event for the steam train whistle might not be the simple placement of the left heel near the right heel but rather the “swiping” of the left heel rapidly past the right heel. Such a swiping motion would create a rapid increase and subsequent decrease in the output of the Hall effect sensor. Software running on controller 12 could interpret this as the triggering “swipe” of the left heel.

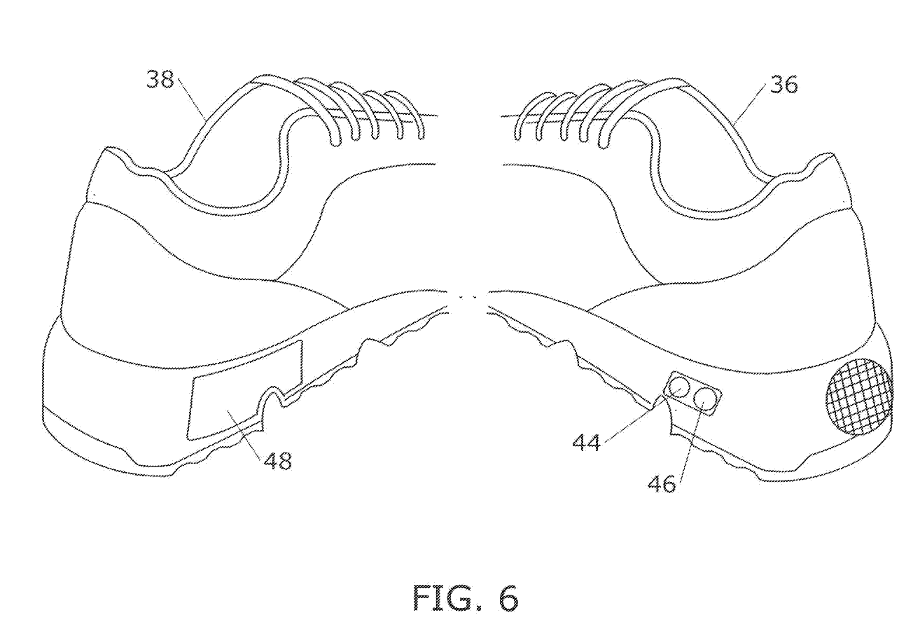

The proximity detection functions of the present invention may also be based on non-magnetic sensors. FIGS. 6-8 illustrate additional embodiments using other sensor types. In FIG. 6, infrared emitter 44 and infrared detector 46 are placed in right shoe 36. The IR emitter projects infrared light and the IR detector is triggered when a reflection of that infrared light is received. Left shoe 38 is provided with reflector/filter 48. This panel filters light wavelengths other than that emitted by IR emitter 44 and reflects light within the hand of IR emitter 44. When the heel of left shoe 33 is placed near right shoe 36, the infrared light from emitter 44 is reflected back to IR detector 46 and the controller within right shoe 36 is thereby “informed” that left shoe 38 is close by. As for the prior example, the detection of proximity may be used to trigger a desired effect, such as the sounding of a steam train whistle.

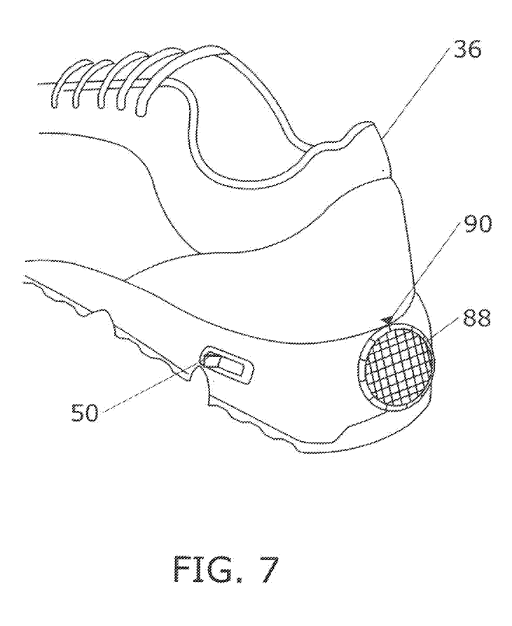

FIG. 7 depicts an embodiment incorporating a much simpler form of proximity detection. Paddle switch 50 is provided on the side of right show 38. The user activates this switch by sliding the left shoe along the side of the right shoe. The switch may be configured to have a neutral middle position that is held in place by centering springs. The user can then activate the switch by swiping the left shoe forward or backward along the side of the right shoe.

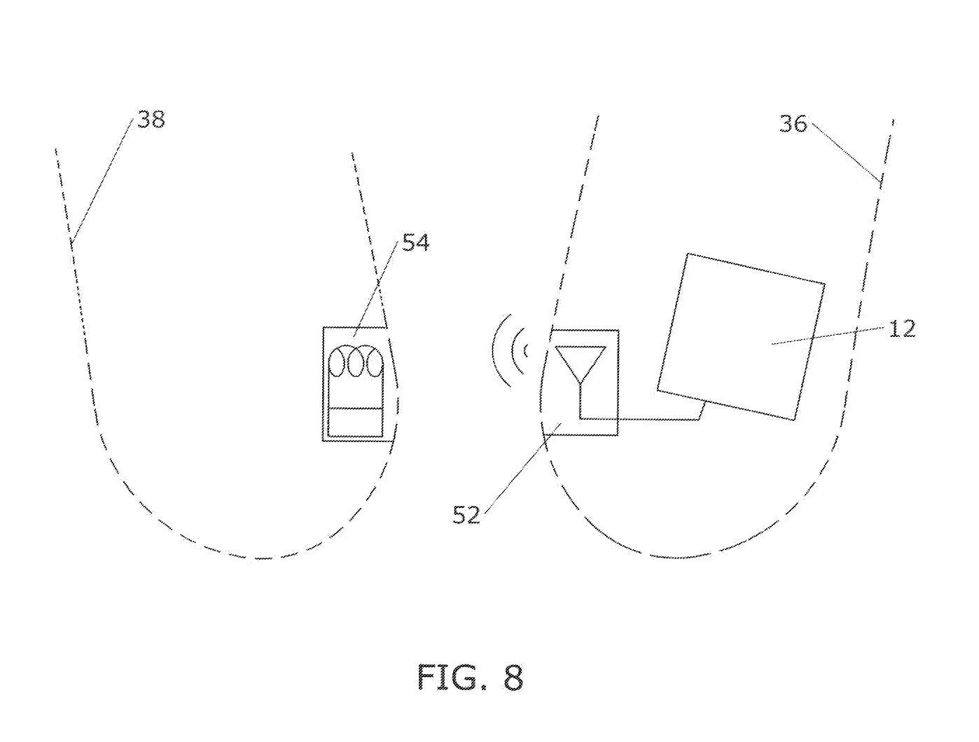

FIG. 8 depicts still another embodiment incorporating a different proximity-detecting mechanism. Left shoe 38 includes RFID response module 54. Right shoe 36 incorporates RFID transceiver 52 connected to controller 12. This embodiment is based on the well-known “RFID tag” technology. It can be passive or active. In the passive version, RFID transmitter 52 transmits an exciting signal. If RFID response module 54 is close enough, this exciting signal activates it and the response module then transmits its own modulated signal. RFID transceiver 52 receives the response signal and thereby detects the presence of left shoe 38.

As those skilled in the art will know, the response signal can contain additional information specifically identifying the RFID response module. In fact, each RFID module installed in a shoe could be given a unique response signal. In this way, controller 12 could be informed of specifically which shoe is in close proximity. This feature allows additional interactions beyond just between a single user's left and right shoes. The proximity of a shoe belonging to a different user could be detected and this event could be used to trigger still another sound effect—such as the closing of a mechanical railroad coupler.

The presence of a radio frequency transceiver connected to controller 12 allows other features as well. It may be desirable from time to time to change some of the parameters stored in the software running on controller 12 or to update the software itself. An external programmer can be used to transmit radio frequency signals to the transceiver. As one example, the pressure threshold for impact sensor 16 may need to be adjusted depending on the weight of the user. An external programmer may be used for this purpose.

Those skilled in the art will also realize that an external programmer need not rely on radio frequency signals to communicate. Light or sound could also be used with a suitable receiver placed in the shoe.

Whatever form the impact sensor (first sensor) and proximity sensor (second sensor) take, it is important that each send a signal to the controller upon the occurrence of the event they are configured to detect. The term “signal” in this context just means something that informs the controller that an event has been detected. If, for example, the second sensor is a magnetic reed switch, the “signal” may simply be the fact that the circuit has been made by the closing of the switch. If the second sensor is a Hall effect sensor, the signal may be a change in voltage output resulting from an increasing magnetic field.

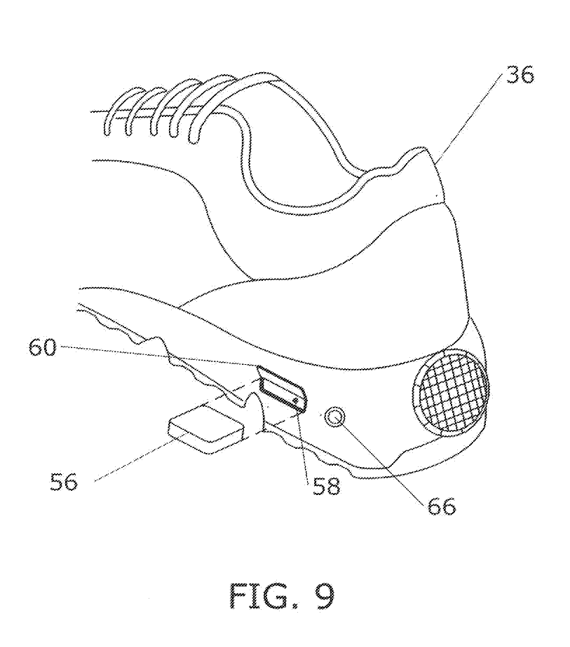

Returning now in FIG. 4 the reader will recall that power source 14 provides electrical energy to the various components of the invention. The stored electrical energy must be replenished from time to time to keep the invention functioning. FIG. 9 shows two approaches to replenishment. In the first approach, a rechargeable battery 56 is used. Receiver 58 receives the battery. Hatch 60 secures the battery in position. When the battery is depleted, the user opens the hatch, removes the battery, and places the battery in a separate charger.

The second approach shown in FIG. 9 is charging port 66. This port provides an electrical connection to an internal charge controller. A separate charger is plugged into charging port 66 in order to recharge the battery.

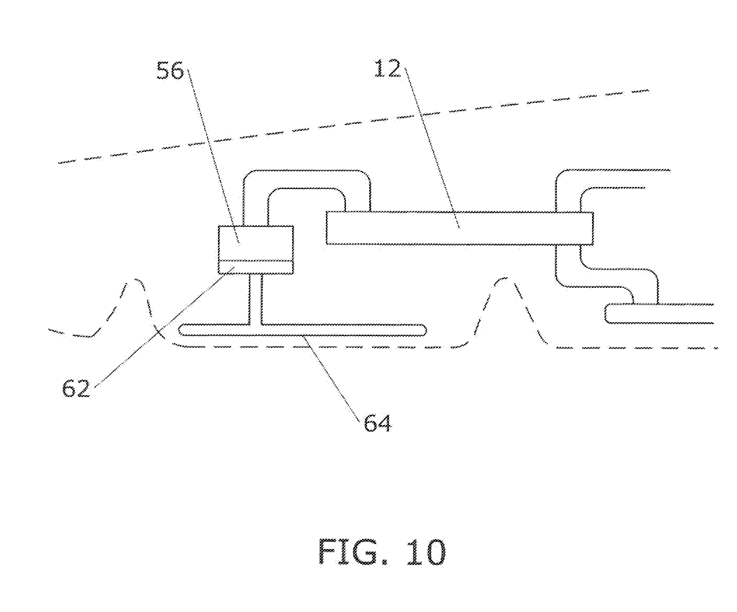

FIG. 10 shows still another embodiment. Charge controller 62 regulates the charging condition of battery 56. Inductive charge antenna 64 inductively receives electrical energy from an external source and feeds it to charge controller 62. In this version the shoe is placed on a charging pad when not in use. The charging pad emits a low level charging signal that is received by inductive charge antenna 64 and conveyed to charge controller 62. This version has the advantage of needing no external portals or connectors. All the components can be sealed within the shoe.

Manual features may also be provided in some embodiments for adjusting the shoe's operating parameters. FIG. 7 shows one such device. Rotary input 88 surrounds the external speaker on the rear of the shoe. The user is able to unlock this rotary dial and turn it to indicate different settings. Index mark 90 is provided as a fixed reference. As one example, the controller could be configured so that four stomps in quick succession causes it to enter the programming mode. Turning rotary input 88 would then alter a selected parameter. Parameters could be announced using instructive recorded sequences such as a voice saying “programming mode entered” or “turn the dial to set sensitivity.” Rotary input 88 could thereby be used to adjust the sensitivity of the impact sensor, the magnetic sensor, or any other parameter.

The impact or magnetic sensors themselves could also be used as input devices. If four stomps put the device in programming mode, then additional stomps could be used to index the parameter being adjusted. Likewise, moving the second shoe next to the magnetic sensor and away again could produce one input pulse for programming purposes.

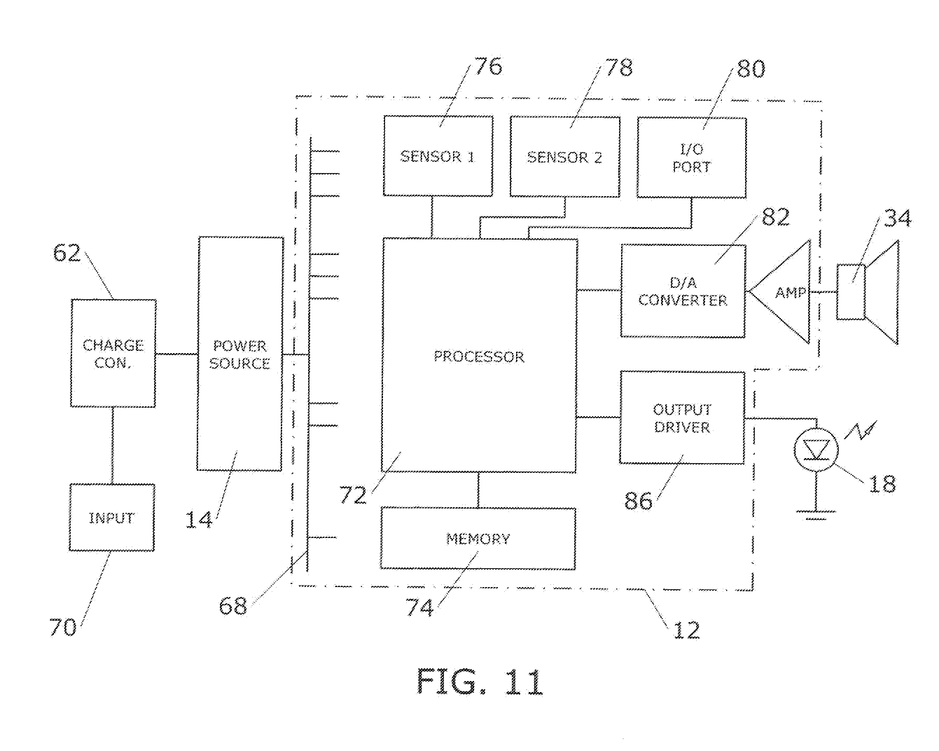

Those skilled in the art will know that controller 12 may assume many different forms. FIG. 11 depicts one exemplary embodiment, among the many different possibilities. Many of the components shown may be included in a single chip or made as an assembly of multiple chips. The reader should therefore properly view the example of FIG. 11 as one possibility among many others.

Controller 12 includes processor 72 and an associated memory 74. The processor runs controlling software and the memory includes stored items, such as multiple digital sound files. When the processor determines that a particular sound file is to be played, it retrieves the file from memory, then outputs it to digital-to-analog converter 82. This device transforms the file to an analog signal. Amplifier 84 then amplifies the analog signal and feeds it to speaker 34, where it is converted to sound waves.

Multiple-sensors 76, 78 provide information to the processor. Examples include an impact sensor and a proximity sensor as described previously. I/O port 80 allows for software updates to be loaded and for other output features (such as a listing of the current state of all the parameters stored in memory 74). Output driver 86 allows the processor to control higher-current external devices such as LED 18 (which may fee used to create a visual flash as for prior art shoes).

Power source 14 is regulated fey charge controller 62 and led power from input 70. In the view powers source 14 includes multiple output branch lines. These are intended to indicate that the power source in this example provides power to all the component shown. This feature may or may not involve multiple connections. As an example, everything shown within the outline of controller 12 might be integrated onto a single chip (an “Application-Specific integrated Circuit”). On the other hand, there might be multiple separate components each needing a separate feed line.

The inventive shoe thus described will have many different applications. The embodiments disclosed pertained to the production of entertaining sounds intended for younger users. However, the shoe could also be useful in other fields. As one example, the shoe could be useful in dance instruction where music is played and the controller detects (1) whether impacts are detected at the correct time, and (2) whether the proximity of the other shoe is detected at the correct time.

Those skilled in the art will realize that many other components and features could be added to the invention, These include:

1. An ultrasonic emitter and detector for the proximity detecting functions;

2. A speaker in the side of the shoe rather than the rear;

3. An adjustment feature that adjusts the pace of sound playback on the basis of how fast the user is running, walking or dancing (by determining an average pace of ground impacts);

4. A capacitive proximity sensor;

5. A proximity sensor based on ambient light;

6. A proximity sensor based on Doppler detection of emitted sounds;

7. An inductive proximity sensor;

8. A radar-based proximity sensor;

9. A sonar-based proximity sensor;

10. An Impact sensor that is a simple mechanical switch; and

11. An impact sensor that includes a piezoelectric element.

Although the preceding description contains significant detail, it should not be construed as limiting the scope of the invention but rather as providing illustrations of the preferred embodiments of the invention. Numerous other permutations and modifications will be apparent to those skilled in the art. As an example, the placement of the speaker in the rear of the shoe is not necessary to the invention and the speaker may in fact he placed in many other locations. These other embodiments are still within the scope of the invention. Thus, the scope of the invention should be fixed by the following claims rather than the examples given.

1. A sound reproducing shoe allowing a user to control the playing of pre-recorded sounds, comprising:
a. a controller;
b. a memory connected to said controller, said memory storing at least two of said pre-recorded sounds;
c. a speaker;
d. a first sensor configured to detect when said user has caused said shoe to contact the ground;
e. a second sensor configured to detect when a second shoe is near said shoe;
f. said controller configured to retrieve a first of said pre-recorded sounds upon receiving a signal from said first sensor and play said sound over said speaker;
g. said controller configured to retrieve a second of said pre-recorded sounds upon receiving a signal from said second sensor and play said sound over said speaker;
h. said controller configured to log a series of said signals from said first sensor and use said logged signals to determine a speed of said user; and
i. said controller configured to alter said first of said pre-recorded sounds based on said determined speed of said user.

2. The sound-reproducing shoe as recited, in claim 1, wherein:
a. said second sensor is a magnetic detector configured to detect the presence of a magnetic field; and
b. said second shoe is equipped with a magnet.

3. The sound-reproducing shoe as recited in claim 2, wherein said second sensor is configured to sense a rate of change in said magnetic field.

4. The sound-reproducing shoe as recited in claim 1, wherein said second sensor is an infrared detector.

5. The sound-reproducing shoe as recited in claim 4, wherein said second sensor is adjustable in sensitivity.

6. The sound-reproducing shoe as recited in claim 1, wherein:
a. said second sensor is a RFID transceiver; and
b. said second shoe is equipped with an RFID response module.

7. The sound-reproducing shoe as recited in claim 6, wherein said second sensor is adjustable in sensitivity.

8. The sound-reproducing shoe as recited in claim 1, wherein:
a. said first of said pre -recorded sounds is the chuff sound of a steam locomotive; and
b. said second of said pre-recorded sounds is the whistle sound of a steam locomotive.

9. The sound reproducing shoe as recited in claim 1, wherein said speaker is located in a heel portion of said shoe.

10. The sound-reproducing shoe as recited in claim 1, further comprising an electrical power source within said shoe configured to feed electrical power to said controller.

11. An improvement to a sound reproducing shoe that includes a controller, a memory connected to said controller, a speaker, and a first sensor configured to detect when said user has caused said shoe to contact the ground, comprising:
a. said controller configured to retrieve a first of said pre-recorded sounds from said memory upon receiving a signal from said first sensor and play said sound over said speaker;
b. said controller configured to log a series of said signals from said first sensor and use said logged signals to determine a speed of said user; and
c. said controller configured to alter said first of said pre-recorded sounds based on said determined speed of said user.

12. The sound-reproducing shoe as recited in claim 11, wherein:
a. said sound reproducing shoe includes a second sensor;
b. said second sensor is a magnetic detector configured to detect the presence of a magnetic field;
c. a second shoe is provided, with said second shoe including a magnet; and
d. said controller is configured to retrieve a second of said pre-recorded sounds upon receiving a signal from said second sensor and play said sound over said speaker.

13. The sound-reproducing shoe as recited in claim 12, wherein said second sensor is configured to sense a rate of change in said magnetic field.

14. (canceled)

15. (canceled)

16. (canceled)

17. The sound-reproducing shoe as recited in claim 13, wherein said second sensor is adjustable in sensitivity.

18. The sound-reproducing shoe as recited in claim 12, wherein:
a. said first of said pre-recorded sounds is the chuff sound of a steam locomotive; and
b. said second of said pre-recorded sounds is the whistle sound of a steam locomotive.

19. The sound-reproducing shoe as recited in claim 11, wherein said speaker is located in a heel portion of said shoe.

20. The sound-reproducing shoe as recited in claim 11, further comprising an electrical power source within said shoe configured to feed electrical power to said controller.
